(19) United States
(12) Patent Application Publication
(10) Pub. No.: US 2009/0310679 A1
(43) Pub. Date: Dec. 17, 2009

(54) VIDEO PROCESSING APPARATUS AND METHODS

(75) Inventors: Te-Hao CHANG, Taipei City (TW); Chin-Chuan LIANG, Taichung City (TW); Siou-Shen LIN, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/137,070

(22) Filed: Jun. 11, 2008

(51) Int. Cl. H04N 7/26

(52) U.S. Cl. 375/240.16; 375/E07.104

(57) ABSTRACT

A video processing apparatus is provided for interpolating frames between two frames. The video processing apparatus includes a motion estimation unit, a region detector and a motion compensation unit. The motion estimation unit receives the two frames and provides motion vector information of the two frames. The region detector generates boundary information associated with image boundaries of the two frames, determines a specific region in the two frames according to the boundary information and generates region information according to the determination result. The motion compensation unit generates an interpolated frame between the two frames in accordance with the region information and the motion vector information.

### BACKGROUND OF THE INVENTION

1. Field of the Invention

The invention relates to video processing, and in particular to processes which involve intermediate frame interpolation.

2. Description of the Related Art

Generally, most video sources, such as films, movies, or animations, have sample rates between 24 to 30 frames per second. In addition, for normal display devices, the display frame rate ranges from 50 to 60 frames per second. Therefore, a conversion of video signals is required to convert the sample rate to the display frame rate.

Traditionally, frame repetition is commonly used to interpolate frames and perform frame rate up-conversion. However, when objects or background of the frames are moving, the conversion process using frame repetition may produce undesirable artifacts, such as movement judder artifacts, thus resulting in deterioration of video quality.

A variety of techniques have been proposed to remove the defects of frame rate conversion, caused by motion of objects in frames, such as motion compensation, wherein a technique of motion judder cancellation (MJC) has been proposed. In MJC technique, an intermediate frame is generated by spatially interpolating the position of objects and background from two successive frames to reducing judder artifacts. Referring to FIG. 1, which is a simplified block diagram illustrating a conventional video processing apparatus for performing motion judder cancellation, a motion estimation unit 102 and a motion compensation unit 104 are provided.

The motion estimation unit 102 derives motion vectors 112 according to at least two successive frames 110. The motion vectors 112 are utilized to instruct the motion compensation unit 104 to locate and access blocks in the reference frames for generation of an intermediate frame 114. Accordingly, the motion compensation unit 104 employs the motion vectors 112 and the successive frames 110 to interpolate the intermediate frame 114, wherein the judder effects of motion are eliminated or reduced.

However, this technique may cause artifacts when one pixel of the intermediate frame is over a moving edge. More specifically, unnatural ringing artifacts, or namely creation of a “halo”, may occur at the boundary of frames with motion. The appearance of a “halo” results from incorrect boundary information derived from the motion estimation unit 102, which fails to match the real boundary of frames with motion. Consequently, ringing artifacts, or so-called “halo”, generates jagged contours or fuzzy lines in the vicinity of sharp edges of objects in motion in the intermediate frame 114, or at the motion boundary of the intermediate frame 114.

### BRIEF SUMMARY OF INVENTION

A video processing apparatus for interpolating frames between two frames is provided. The video processing apparatus comprises a motion estimation unit, a region detector and a motion compensation unit. The motion estimation unit receives the two frames and provides motion vector information of the two frames. The region detector generates boundary information associated with image boundaries of the two frames, determines a specific region in the two frames according to the boundary information and generates region information according to the determination result. The motion compensation unit generates an interpolated frame between the two frames in accordance with the region information and the motion vector information.

A video processing method for interpolating frames between two frames is further provided. The video processing method comprises: receiving the two frames; estimating motion vector information of the two frames; generating boundary information associated with image boundaries of the two frames; determining a specific region in the two frames according to the boundary information; generating region information according to the determination result; and generating an interpolated frame between the two frames in accordance with the region information and the motion vector information.

Another machine-readable storage medium storing a computer program which, when executed by a video processing apparatus, performs the video processing method is provided.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a simplified block diagram illustrating a conventional video processing apparatus for performing motion judder compensation;

FIG. 2 shows a video processing apparatus according to an exemplary embodiment of the invention;

FIGS. 3A, 3B and 3C are diagrams used to explain an operation of frame interpolation according to the exemplary embodiment of FIG. 2;

FIGS. 4A and 4B are illustrations of the interpolation process according to the conventional video processing apparatus of FIG. 1 and the exemplary embodiment of FIG. 2; and

FIG. 5 is a flowchart of a video processing method according to still another exemplary embodiment of the invention removing ringing artifacts of interpolation.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

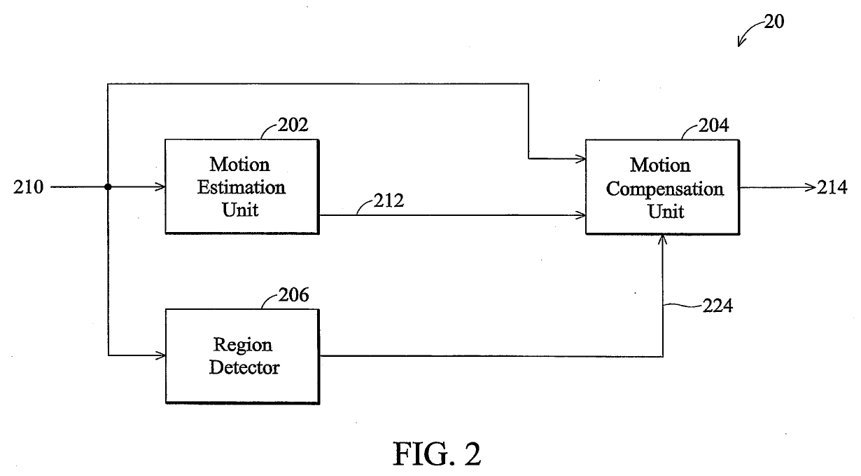

FIG. 2 shows a video processing apparatus 20 according to an exemplary embodiment of the invention. The video processing apparatus 20 comprises a motion estimation unit 202, a motion compensation unit 204, and a region detector 206.

The motion estimation unit 202 receives a sequence of frames, for example, two frames 210. In an embodiment of the invention, the two frames 210 are successive frames. The motion estimation unit 202 subsequently performs motion estimation according to pertinent block data of the frames and outputs motion vector information 212 of objects moving in the two frames 210. The region detector 206 generates boundary information corresponding to image boundaries of the two frames 210, determines a specific region in the two frames 210 according to the boundary information and generates region information 224 according to the determination result. In an embodiment of the invention, the specific region is an invalid region. When all of the invalid regions in the two frames 210 have been designated with the region information 224, the region detector 206 provides the region information 224 to the motion compensation unit 204 for motion compensation. The motion compensation unit 204 interpolates the two frames 210 to generate an interpolated frame 214 according to the region information 224. In details, in accordance with the region information 224, the motion compensation unit 204 assigns a first predetermined weighting factor, such as low weighting factors, to the invalid regions and a second predetermined weighting factor to regions other than the invalid regions. For example, a weighting factor suitable for the invalid regions is zero to prevent ringing artifacts in the interpolation process. Also, movement of objects in the two frames is compensated based on the region information 224 and the motion vector information 212 from the motion estimation unit 202.

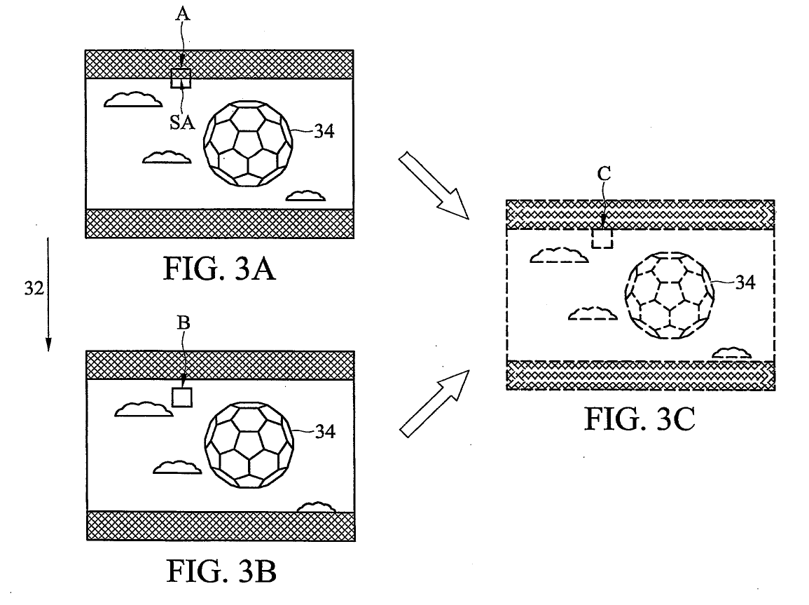

FIGS. 3A, 3B and 3C are diagrams used to explain an operation of frame interpolation according to the exemplary embodiment of FIG. 2. FIGS. 3A and 3B indicate the original frames N and N+1 respectively. FIG. 3C shows an interpolated frame 214 from the motion compensation unit 204 of FIG. 2. Referring to FIGS. 3A and 3B, there is a foreground object 34 over the background scene which does not move while the background moves in the direction of the arrow 32. The blocks A and B indicate the same position corresponding to the original frames N and N+1 respectively.

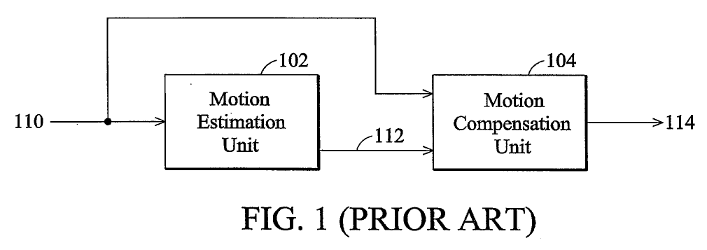

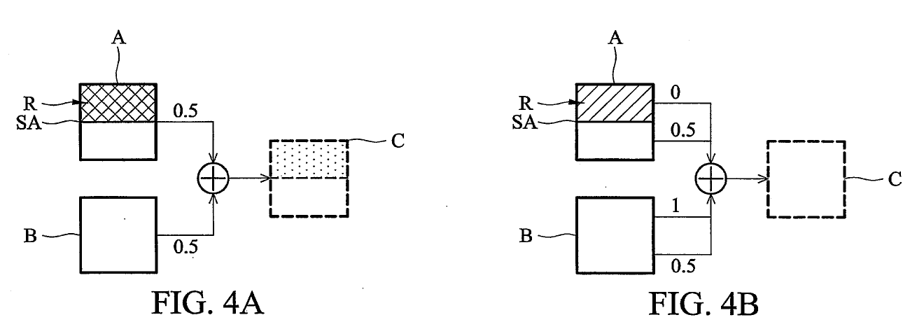

Further, FIG. 4A is an illustration of the interpolation process according to the conventional video processing apparatus of FIG. 1 and the original frames shown in FIGS. 3A and 3B. FIG. 4B is another illustration of the interpolation process according to the exemplary embodiment of FIG. 2 and the original frames shown in FIGS. 3A and 3B. Next, the interpolation process according to the video processing apparatus of the prior art and the invention will be described with reference to the accompanying drawings.

As shown in FIG. 4A, the block C is generated by averaging the blocks A and B according to the aforementioned prior art, wherein an equal weighting factors are assigned to the blocks A and B to obtain the block C. Note that block A contains a region R outside the boundary of the original frame N. Therefore, “halo” is generated in the upper portion of block C, creating a fuzzy, gray line along the boundary of the interpolated frame and further deteriorating the video quality.

In addition, referring to FIGS. 2, 3A, 3B, and 4B, a boundary SA of the block A is detected as the boundary of the frame N by the region detector 206. In this case, the region detector 206 then obtains the boundary information with respect to the boundary SA of the block A. The region detector 206 proceeds to determine that the region R of the block A is an invalid region according to the boundary information since the region R is outside the boundary SA of the block A. Moreover, the region detector 206 provides the region information 224 indicating the region R of the block A is an invalid region to the motion compensation unit 204. Upon receiving the region information 224, the motion compensation unit 204 assigns a first predetermined weighting factor such as a low weighting factor or a zero weighting factor, to the invalid region, i.e., the region R. In this case, the weighting factor of the region R is zero. A region in the block B corresponding to the invalid region, region R, is subsequently assigned a high weighting factor equal to (1−the weighting factor of the region R), such as 1 in this case. The weighting factors assigned to other regions in the blocks A and B, which are not determined to be invalid regions, such as the other region in the block A and its corresponding region in the block B remains the same, where in this case, a second predetermined weighting factor for valid regions are 0.5. Finally, the motion compensation unit 204 performs motion-compensated interpolation of blocks A and B according to the assigned weighting factors and produces the resulting interpolated block C with no “halo” artifacts.

Note that there are a variety of well known techniques available for obtaining the image boundary information of frames, for example, a predetermined threshold level may be used to determine the boundary of a frame. For this technique, the boundary detection method using the predetermined threshold level performs a scan operation for the frame from upper lines to lower lines. During the scan operation, the first line, denoted by line N, having a greater luminance value than the predetermined threshold level, is identified. Additionally, the last line, denoted by line M, having a greater luminance value than the predetermined threshold level, is further identified. As a result, an upper boundary (line N) and a lower boundary (line M) of the frame are determined. More specifically, the region which is not placed between lines N and M is defined as an outside region, or an invalid region. That is, the invalid region in the frame may comprise a plurality of regions above the upper boundary and below the lower boundary. It should be noted that other boundary detection techniques can be used as desired, in addition to the method described above.

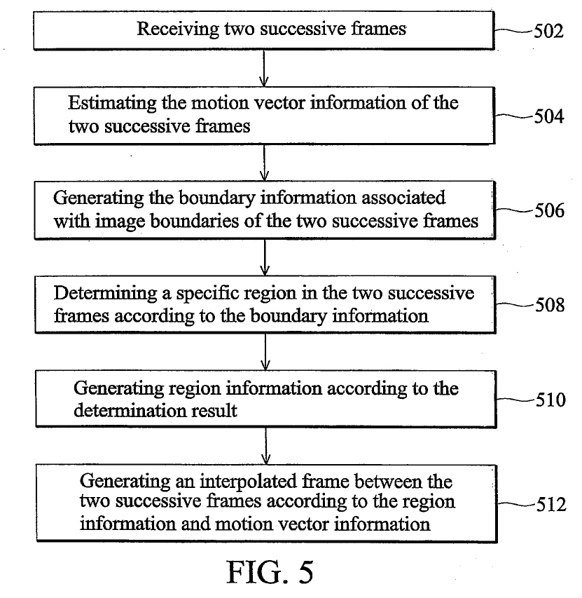

FIG. 5 is a flowchart of a video processing method according to still another exemplary embodiment of the invention for interpolating frames between two frames. According to the embodiment of the invention, the video processing method provided for reducing “halo” first receives a sequence of frames, such as two frames (step 502). In an embodiment of the invention, the two frames are successive. Then, the motion vector information of the two frames is estimated (step 504). The boundary information associated with image boundaries of the two frames is subsequently generated (step 506). Further, a specific region in the two frames is determined according to the boundary information (step 508). For example, regions outside the boundaries of the two frames are deemed as the specific region. In an embodiment of the invention, the specific region is referred as an invalid region. Next, region information is generated according to the determination result (step 510). As a result, an interpolated frame between the two frames is generated in accordance the region information and the motion vector information (step 512). More specifically, a low weighting factor or a zero weighting factor is provided to the invalid region. Note that, since operations of generating the boundary information are stated in aforementioned embodiments, description thereof is omitted for brevity.

It is noted that video processing apparatus and methods according to embodiments of the invention for interpolating frames between two frames, or certain aspects or portions thereof, may take the form of program code, i.e., instructions, embodied in tangible media, such as floppy diskettes, hard drives, nonvolatile memory devices, CD-ROMs, or any other machine-readable storage medium, wherein, when the program code is loaded into and executed by a machine, such as a video processing apparatus or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, such as a computer, a video processing apparatus or similar, the machine becomes an apparatus for practicing the invention. When implemented on a general-purpose processor, the program codes combine with the processor to provide a unique apparatus that operate analogously to specific logic circuits.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A video processing apparatus for interpolating frames between two frames, comprising:
a motion estimation unit for receiving the two frames and providing motion vector information of the two frames;
a region detector for generating boundary information associated with image boundaries of the two frames, determining a specific region in the two frames according to the boundary information and generating region information according to the determination result; and
a motion compensation unit for generating an interpolated frame between the two frames in accordance with the region information and the motion vector information.

2. The video processing apparatus of claim 1, wherein the boundary information is generated by scanning the two frames and determining an upper boundary and a lower boundary corresponding to each of the two frames, wherein lines corresponding to the upper boundary and lower boundary of each of the two frames are respectively the first and last lines of corresponding frame having luminance levels exceeding a threshold level.

3. The video processing apparatus of claim 2, wherein the specific region comprises regions above the upper boundary and regions below the lower boundary.

4. The video processing apparatus of claim 1, wherein the motion compensation unit assigns first and second predetermined weighting factors to the specific region and regions other than the specific region in the two frames respectively according to the region information to generate the interpolated frame.

5. The video processing apparatus of claim 4, wherein the second predetermined weighting factor is larger than the first predetermined weighting factor.

6. The video processing apparatus of claim 4, wherein the first predetermined weighting factor is zero.

7. The video processing apparatus of claim 1, wherein the two frames are successive frames.

8. A video processing method for interpolating frames between two frames, comprising:
receiving the two frames;
estimating motion vector information of the two frames;
generating boundary information associated with image boundaries of the two frames;
determining a specific region in the two frames according to the boundary information;
generating region information according to the determination result; and
generating an interpolated frame between the two frames in accordance with the region information and the motion vector information.

9. The video processing method of claim 8, wherein the step of generating the boundary information comprises:
scanning the two frames;
determining an upper boundary corresponding to each of the two frames; and
determining a lower boundary corresponding to each of the two frames,
wherein lines corresponding to the upper boundary and the lower boundary of each of the two frames are respectively first and last lines of corresponding frame having luminance levels exceeding a threshold level.

10. The video processing method of claim 9, wherein the specific region comprises regions above the upper boundary and regions below the lower boundary.

11. The video processing method of claim 8, wherein generating the interpolated frame comprises assigning first and second predetermined weighting factors to the specific region and regions other than the specific region in the two frames respectively according to the region information.

12. The video processing method of claim 11, wherein the second predetermined weighting factor is larger than the first predetermined weighting factor.

13. The video processing method of claim 11, wherein the first predetermined weighting factor is zero.

14. A machine-readable storage medium for storing a computer program which when executed performs a video processing method, the method comprising:
receiving the two frames;
estimating motion vector information of the two frames;
generating boundary information associated with image boundaries of the two frames;
determining a specific region in the two frames according to the boundary information;
generating region information according to the determination result; and
generating an interpolated frame between the two frames in accordance with the region information and the motion vector information.

15. The machine-readable storage medium of claim 14, wherein the step of generating the boundary information comprises:
scanning the two frames;
determining an upper boundary corresponding to each of the two frames; and
determining a lower boundary corresponding to each of the two frames,
wherein lines corresponding to the upper boundary and the lower boundary of each of the two frames are respectively the first and last lines of corresponding frame having luminance levels exceeding a threshold level.

16. The machine-readable storage medium of claim 15, wherein the specific region comprises regions above the upper boundary and regions below the lower boundary.

17. The machine-readable storage medium of claim 14, wherein generating the interpolated frame comprises assigning first and second predetermined weighting factors to the specific region and regions other than the specific region in the two frames respectively according to the region information.

18. The machine-readable storage medium of claim 17, wherein the second predetermined weighting factor is larger than the first predetermined weighting factor.

19. The machine-readable storage medium of claim 17, wherein the first predetermined weighting factor is zero.
